(19) United States
(12) Patent Application Publication
(10) Pub. No.: US 2014/0235216 A1
(43) Pub. Date: Aug. 21, 2014

(54) USING BODYCOM TO MODIFY THE CONFIGURATION OF A DEVICE BASED UPON CONTEXT

(71) Applicant: MICROCHIP TECHNOLOGY INCORPORATED, Chandler, AZ (US)

(72) Inventor: Lance Lamont, Brookfield, WI (US)

(73) Assignee: MICROCHIP TECHNOLOGY INCORPORATED, Chandler, AZ (US)

(21) Appl. No.: 13/769,690

(22) Filed: Feb. 18, 2013

(51) Int. Cl. H04W 4/04

(52) U.S. Cl. CPC H04W 4/046
USPC 455/418

(57) ABSTRACT

Context of a device is controlled by a short-range wireless connectivity technology that uses the human body to transport wireless signals that may be easily distinguished between proximate locations, e.g., a vehicle driver location and a passenger location. The devices that communicate with this short-range wireless connectivity technology must be within a few centimeters of a user's body. Visual features of the device may be disabled when the user is located in a certain specific location, e.g., driver seat while driving the vehicle.

### TECHNICAL FIELD

The present disclosure relates to context control of an electronic device, and in particular, to location specific control of the electronic device's configuration.

### BACKGROUND

Using a cell phone while driving, e.g., dialing, texting, talking while holding the cell phone, web browsing, etc., has contributed to automobile accidents. Cell phone use that distracts a driver has been outlawed in a number of states and more states are considering passing legislation to ban distractive uses of the cell phone while driving. Passing laws to stop cell phone distraction abuses do not necessarily accomplish their intended purpose as people will do whatever they think that they can get away with when the police are not around.

### SUMMARY

Therefore what is needed is a fool proof way of preventing cell phone use abuse while driving.

According to an embodiment, a method for modifying a device based upon context, may comprise the steps of: transmitting a command signal through a body of a user of said device; receiving the command signal from the body of the user with said device; and determining whether to modify at least one feature of said device based upon the command signal.

According to a further embodiment of the method, the device may be selected from the group consisting of a cell phone, a smart phone, a personal digital assistant, a game tablet, a touch pad computer, and a portable computer. According to a further embodiment of the method, the at least one feature may be at least one visual feature of said device.

According to a further embodiment of the method, the step of waking up said device from a low power mode may be when the command signal is received. According to a further embodiment of the method, the step of waking up said device from a low power mode may be when the user is in close proximity to said device. According to a further embodiment of the method, the step of waking up said device from a low power mode may be when the user touches said device.

According to a further embodiment of the method, the step of enabling a hands free speaker mode in said device may be when the command signal is received. According to a further embodiment of the method, the step of enabling a hands free speaker mode may comprise the step of enabling Bluetooth operation from said device. According to a further embodiment of the method, the step of enabling a hands free speaker mode may comprise the step of enabling speaker phone operation in said device.

According to a further embodiment of the method, the command signal may be transmitted from a vehicle seat in a vehicle. According to a further embodiment of the method, the vehicle seat may be a driver seat and the command signal disables the at least one feature of said device. According to a further embodiment of the method, the vehicle seat may be a driver seat and the command signal may enable the at least one feature of said device when the vehicle is not moving.

According to a further embodiment of the method, the at least one feature may be at least one visual feature of said device. According to a further embodiment of the method, the vehicle seat may be a passenger seat and the command signal may enable the at least one feature of said device. According to a further embodiment of the method, the at least one feature may be at least one visual feature of said device. According to a further embodiment of the method, when no command signal is received by said device the at least one feature thereof may be re-enabled after a certain time period.

According to another embodiment, a system for modifying a device based upon context may comprise: transmitting apparatus for sending a command signal through a body of a user of said device; receiving apparatus in said device for receiving the command signal from the body of the user of said device; and logic circuits for determining whether to modify at least one feature of said device based upon the command signal.

According to a further embodiment, the transmitting apparatus may comprise: a microcontroller; a transmitter coupled to the microcontroller; and a first coupling element coupled to the transmitter. According to a further embodiment, the receiving apparatus may comprise: a second coupling element; a receiver coupled to the second coupling element; and a configuration processor coupled to the receiver, wherein the configuration processor may control at least one feature of said device.

According to a further embodiment, the at least one feature may be at least one visual feature of said device. According to a further embodiment, the device may be selected from the group consisting of a cell phone, a smart phone, a personal digital assistant, a game tablet, a touch pad computer, and a portable computer. According to a further embodiment, waking up said device from a low power mode may be when the command signal is received.

According to a further embodiment, a proximity sensor may be used for waking up said device from a low power mode when said user is in proximity to said device. According to a further embodiment, a proximity sensor may be used for waking up said device from a low power mode when said user touches said device.

According to a further embodiment, the transmitting apparatus may be located in a vehicle seat. According to a further embodiment, the vehicle seat may be a driver seat. According to a further embodiment, the vehicle seat may be a passenger seat.

### BRIEF DESCRIPTION OF THE DRAWINGS

A more complete understanding of the present disclosure may be acquired by referring to the following description taken in conjunction with the accompanying drawings wherein:

FIG. 1 illustrates a diagram of an automobile interior showing front and back seats, and locations for proximity detection and coupling pads imbedded in the seats, according to a specific example embodiment of this disclosure;

FIG. 2 illustrates a schematic plan view of specific example embodiments of the proximity detection and coupling pads shown in FIG. 1; and

FIG. 3 illustrates a schematic block diagram of a transmitter, proximity detection and coupling pads, a cell phone and a cell phone user, according to specific example embodiments of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Proscriptive laws on how and when to use a cell phone or touch pad computer while driving a vehicle will not prevent thoughtless and irresponsible use thereof that can cause a vehicle accident with subsequent loss of property and, worse yet, loss of life. Preventing dangerous uses of the cell phone or touch pad computer while driving by disabling visual interaction therewith is a much more effective deterrent. However, preventing full use of a cell phone or touch pad computer to a passenger in a vehicle is not desirable either. Therefore selective reconfiguration of the visual functions of the cell phone or touch pad computer based upon user location in the vehicle is preferred. Automatic restoration of the visual functions thereof when the cell phone or touch pad computer is passed from the driver to a passenger in the vehicle is also desirable.

A short-range wireless connectivity technology that uses the capability of the human body to transport wireless signals can provide location specific communications paths that may be easily distinguished between a driver location and a passenger location. This short-range wireless connectivity technology is described more fully in Microchip Technology Inc., application note AN1391, entitled “Introduction to the BodyCom Technology,” available at www.microchip.com, and is incorporated by reference herein for all purposes. Devices that communicate with this short-range wireless connectivity technology must be within a few centimeters of a user's body, e.g., hand, back, buttock, etc., but are not required to come in physical contact with the user.

Due to the high permittivity of the human body at low radio frequencies, communications between devices can be achieved with simple radio frequency transmission and reception devices operating at any frequency(ies) from about 60 kHz to about 30 MHz. Furthermore, a battery powered device, e.g., cell phone, smart phone, personal digital assistant, game tablet, touch pad computer, portable computer, etc., can stay in a very low power standby or sleep state. Then capacitive proximity sensing may be used to wake-up the device when touched or in close proximity thereto for further processing of the radio frequency signals received through the closely coupled part of the user's body.

According to the teachings of this disclosure, a short-range wireless signal may be transmitted over “skin,” with a very short proximity range in air. Thus two devices, both in close proximity with a person (user), e.g., through clothing, gloves, near to or touching skin, etc., can communicate, but a device not in close proximity to the person (user) will not be able to communicate. This close proximity to or direct physical contact with a user may be used to reconfigure a device based upon the context of the user, e.g., vehicle driver versus passenger. When the vehicle is moving, a device in close proximity to or in contact with the driver would cease all visual functionality, e.g., email, texting, web browsing, etc., and when the vehicle was not moving, e.g., neutral, park, foot on brake, the visual functionality would return. In addition, hands free operation, e.g., speaker phone, Bluetooth, etc., of the cell phone can also be enabled when the vehicle is in motion. Alternatively, the device could stay in a non-visually enabled mode until another user was in close proximity to or touching the device, e.g., driver gives cell phone or touch pad (tablet) computer to a passenger in the vehicle.

Referring now to the drawing, the details of specific example embodiments are schematically illustrated. Like elements in the drawings will be represented by like numbers, and similar elements will be represented by like numbers with a different lower case letter suffix.

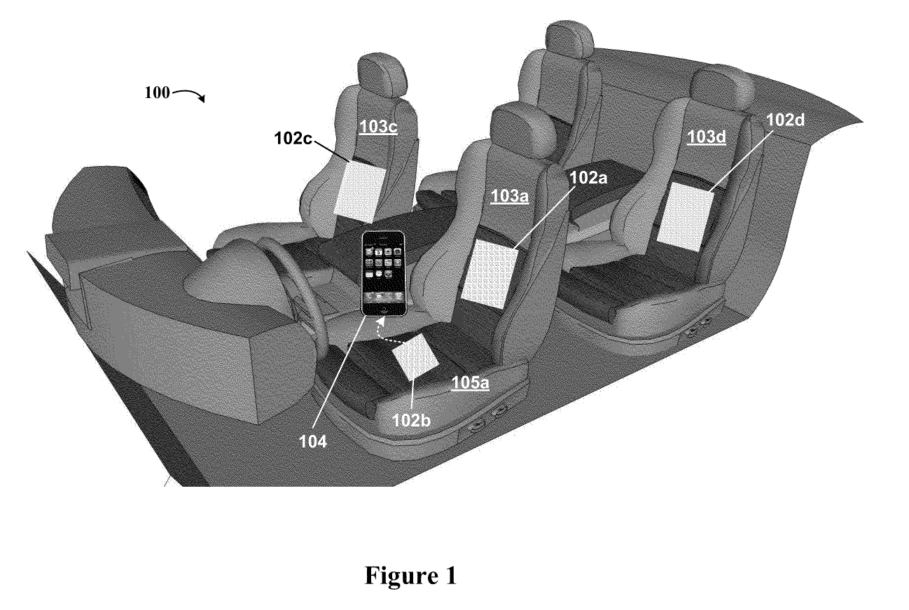

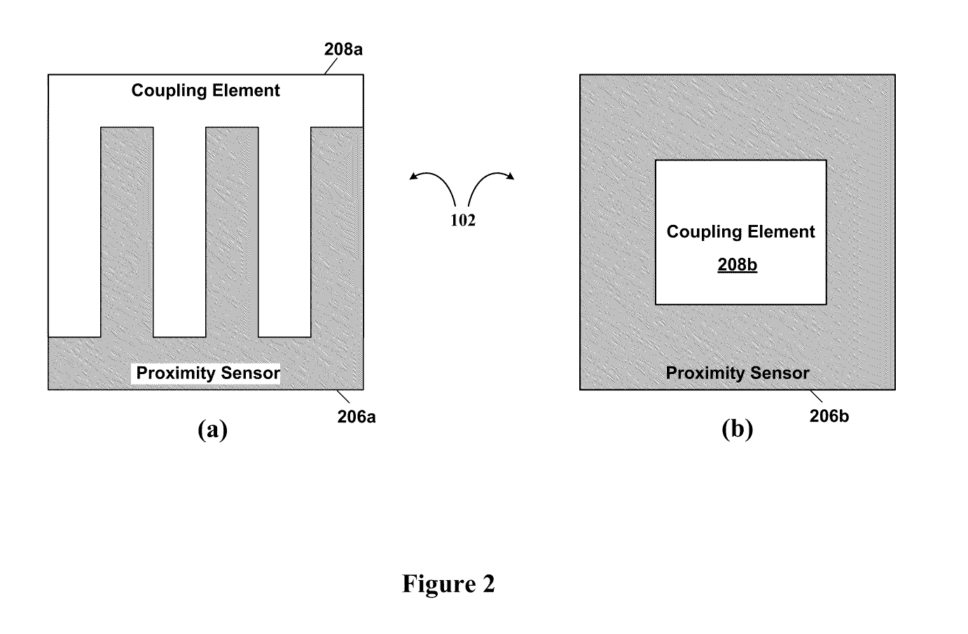

Referring to FIG. 1, depicted is a diagram of an automobile interior showing front and back seats, and locations for proximity detection and coupling pads imbedded in the seats, according to a specific example embodiment of this disclosure. An interior of a vehicle 100, may comprise a driver seat 103a, a front passenger seat 103c, and rear passenger seats 103d. In the driver seat 103a a proximity detection and coupling pad 102a may be located in a back portion of the seat 103a, and/or a proximity detection and coupling pad 102b may be located in a bottom portion 105a of the seat 103a. The proximity detection and coupling pad 102 may comprise a coupling element 208, or a coupling element 208 and a proximity sensor 206 (FIG. 2). Proximity detection and coupling pads 102c and 102d may also be located in the seats 103c and 103d, respectively, but are not necessary. A configurable device 104, according to the teachings of this disclosure, may be in close proximity to or held by a driver (not shown) sitting in the driver seat 103a, or by a passenger (not shown) sitting in a passenger seat 103c or 103d.

Referring to FIG. 2, depicted is a schematic plan view of specific example embodiments of the proximity detection and coupling pads shown in FIG. 1. The proximity detection and coupling pad 102 shown in FIG. 2(a) comprises a finger style proximity sensor 206a and a coupling element 208a. The proximity detection and coupling pad 102 shown in FIG. 2(b) comprises a proximity sensor 206b and a coupling element 208b in the center of the proximity sensor 206b. These are but two of many different possibilities for the proximity sensor 206 and the coupling element 208. A more detailed description of coupling elements and proximity sensors are described in Microchip Application Note AN1391, previously incorporated by reference herein. The proximity sensor 206 is optional and may be deleted from the proximity detection and coupling pad 102 which will then become a coupling pad 102 only used for BodyCom communications only. The proximity sensor 206 may be used to detect when a user is in close proximity to the device 104 so that the device 104 may automatically come out of a low power mode into an operational mode.

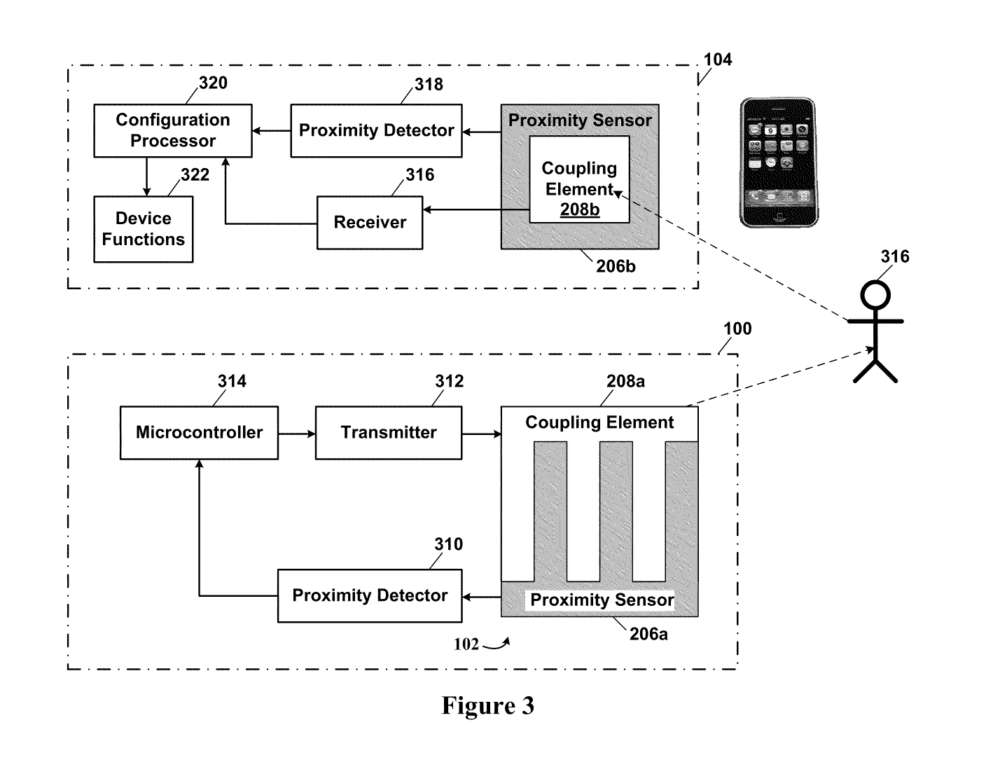

Referring to FIG. 3, depicted is a schematic block diagram of a transmitter, a proximity detection and coupling pad, a cell phone and a cell phone user, according to specific example embodiments of this disclosure. A device 104 may comprise a proximity sensor 206b, a coupling element 208b, a proximity detector 318, a receiver 316, a configuration processor 320 and controllable device functions 322. A proximity detection and coupling pad 102 located in a seat 103 may comprise a proximity sensor 206a, a coupling element 208a, a proximity detector 310, a transmitter 312 and microcontroller 314.

For device 104, the proximity sensor 206b is coupled to the proximity detector 318 which is coupled to the configuration processor 320. The proximity detector 318 in combination with the proximity sensor 206b senses an object, e.g., a hand, in close proximity or touching by a change in the capacitance value of the proximity sensor 206b. The device 104 may use this proximity sensing and detection to wake-up circuits that are in a low power sleep mode.

For vehicle 100, the proximity sensor 206a is coupled to the proximity detector 310 which is coupled to the microcontroller 314. The proximity detector 310 in combination with the proximity sensor 206a senses an object, e.g., a back or buttock, in close proximity to or touching, by a change in the capacitance value of the proximity sensor 206a. The vehicle 100 may use this proximity detection to wake-up circuits that are in a low power sleep mode. The wake-up functions described hereinabove are optional and may be used to conserve power in a battery operated device, e.g., cell phone, touch pad PC, etc.

The microcontroller 314 may control the transmitter 312 to transmit a disable visual functions command when associated with the proximity detection and coupling pad 102a in driver seat 103a, or an enable visual functions command when associated with the proximity detection and coupling pads 102c and 102d in the passenger seats 103c and 103d. The microcontroller 314 may also control the transmitter 312 through the coupling element 208a located in the driver seat 103a to transmit an enable visual functions command when the vehicle is not moving, e.g., stopped, in neutral and/or park.

The transmitter 312 couples a radio frequency signal, e.g., from about 60 kHz to about 30 MHz, into the coupling element 208a. The radio frequency signal is modulated with the enable or disable visual functions command. The radio frequency signal is coupled through the body of a user 316 to the coupling element 208b in the device 104. The receiver 316 detects and demodulates the radio frequency signal and provides the demodulated visual functions command to the configuration processor 320. The configuration processor 320 then determines whether to enable or disable device visual functions 322.

It is contemplated and within the scope of this disclosure that the optional proximity sensors and proximity detectors may only be needed when providing a wake-up from a low power sleep mode feature. The wake-up from a low power sleep mode feature may also be provided when a command signal is received without the necessity of proximity detection of a user. Therefore, just the coupling elements 208, transmitter 313 and receiver 316 are necessary for communications through a user's body using the BodyCom Technology, according to the teachings of this disclosure. Furthermore, only a coupling pad 102b is required in the driver's seat 103a since the disable visual functions command need only be present when a person is sitting in the driver's seat 103a and using the device 104. Once the device 104 is handed to another person the disable visual functions command will go away since there will be no BodyCom communications between a passenger and a passenger seat. Thus a simple loss of BodyCom communications time out in the device 104 may be used to re-enable visual functions thereof.

The configuration processor 320 may also enable and disable Bluetooth connectivity in the device 104 for further conservation of battery power. Since no transmit functionality of the device 104 is required, low power operation is preserved, according to the teachings of this disclosure. Bluetooth is a feature that may be used to provide hands free speaker phone operation of the device 104 in a non-visual operating mode.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A method for modifying a device based upon context, said method comprising the steps of:
transmitting a command signal through a body of a user of said device;
receiving the command signal from the body of the user with said device; and
determining whether to modify at least one feature of said device based upon the command signal.

2. The method according to claim 1, wherein the device is selected from the group consisting of a cell phone, a smart phone, a personal digital assistant, a game tablet, a touch pad computer, and a portable computer.

3. The method according to claim 1, wherein the at least one feature is at least one visual feature of said device.

4. The method according to claim 1, further comprising the step of waking up said device from a low power mode when the command signal is received.

5. The method according to claim 1, further comprising the step of waking up said device from a low power mode when the user is in close proximity to said device.

6. The method according to claim 1, further comprising the step of waking up said device from a low power mode when the user touches said device.

7. The method according to claim 1, further comprising the step of enabling a hands free speaker mode in said device when the command signal is received.

8. The method according to claim 7, wherein the step of enabling a hands free speaker mode comprises the step of enabling Bluetooth operation from said device.

9. The method according to claim 7, wherein the step of enabling a hands free speaker mode comprises the step of enabling speaker phone operation in said device.

10. The method according to claim 1, wherein the command signal is transmitted from a vehicle seat in a vehicle.

11. The method according to claim 10, wherein the vehicle seat is a driver seat and the command signal disables the at least one feature of said device.

12. The method according to claim 10, wherein the vehicle seat is a driver seat and the command signal enables the at least one feature of said device when the vehicle is not moving.

13. The method according to claim 11, wherein the at least one feature is at least one visual feature of said device.

14. The method according to claim 10, wherein the vehicle seat is a passenger seat and the command signal enables the at least one feature of said device.

15. The method according to claim 14, wherein the at least one feature is at least one visual feature of said device.

16. The method according to claim 10, wherein when no command signal is received by said device the at least one feature thereof is re-enabled after a certain time period.

17. A system for modifying a device based upon context, said system comprising:
transmitting apparatus for sending a command signal through a body of a user of said device;
receiving apparatus in said device for receiving the command signal from the body of the user of said device; and
logic circuits for determining whether to modify at least one feature of said device based upon the command signal.

18. The system according to claim 17, wherein the transmitting apparatus comprises:
a microcontroller;
a transmitter coupled to the microcontroller; and
a first coupling element coupled to the transmitter.

19. The system according to claim 17, wherein the receiving apparatus comprises:
a second coupling element;
a receiver coupled to the second coupling element; and
a configuration processor coupled to the receiver, wherein the configuration processor controls at least one feature of said device.

20. The system according to claim 19, wherein the at least one feature is at least one visual feature of said device.

21. The system according to claim 17, wherein the device is selected from the group consisting of a cell phone, a smart phone, a personal digital assistant, a game tablet, a touch pad computer, and a portable computer.

22. The system according to claim 19, further comprising waking up said device from a low power mode when receiving the command signal.

23. The system according to claim 19, further comprising a proximity sensor for waking up said device from a low power mode when said user is in proximity to said device.

24. The system according to claim 19, further comprising a proximity sensor for waking up said device from a low power mode when said user is touching said device.

25. The system according to claim 17, wherein the transmitting apparatus is located in a vehicle seat.

26. The system according to claim 25, wherein the vehicle seat is a driver seat.

27. The system according to claim 25, wherein the vehicle seat is a passenger seat.
